(19) United States
(12) Patent Application Publication
(10) Pub. No.: US 2008/0090474 A1
(43) Pub. Date: Apr. 17, 2008

(54) ELECTRICAL CONNECTOR WITH PIVOTING TERMINAL

(75) Inventor: Ted Ju, Keelung (TW)

Correspondence Address: TROXELL LAW OFFICE PLLC, ONE SKYLINE PLACE , SUITE 1404, 5205 LEESBURG PIKE, FALLS CHURCH, VA, 22041, US

(73) Assignee: LOTES CO., LTD.

(21) Appl. No.: 11/580,286

(22) Filed: Oct. 13, 2006

(51) Int. Cl. H01R 4/50

(52) U.S. Cl. 439/864

(57) ABSTRACT

The present invention discloses an electrical connector, comprising an insulating body provided with a plurality of accommodating passages; and an electrical terminal received in the accommodating passage and having a fastening portion on one side to fasten with the insulating body and a contact portion on the other side to be swingingly connected with. Compared with the conventional art, the electrical connector according to the present invention can maintain better resilience without loosening and thus ensure secure electrical connection with mating electronic components.

### FIELD OF THE INVENTION

The present invention relates to an electrical connector, and in particular to an electrical connector which is used to connect the land grid array (LGA) chip module to a circuit board.

### BACKGROUND OF THE INVENTION

The conventional art of an electrical connector usually connects the LGA chip module to a circuit board, wherein the electrical connector usually comprises electrical terminals. U.S. Pat. No. 6,488,513 discloses an electrical connector which can provide densely spaced contact pads on both ends to compressingly contact with mating electronic components, comprising electrical terminals and an insulating body, wherein the electrical terminal is a C-shape comprising an upper and lower resilient contact arms as well as a body. The upper and lower resilient contact arms extend from the opposite sides of the insulating main body and the lower resilient arm is generally a shape of inclined slot whose end can be pressed against the metal contact of the electronic component (electrical circuit).

However, the drawback of the aforementioned US patent lies in the fact that the poor fatigue resistance of the electrical terminal will negatively affect the electrical connection with its mating electronic components when the resilience of the terminal diminishes after repetitive uses.

Consequently, it is necessary to design a new electrical connector to overcome the aforementioned drawback.

### SUMMARY OF THE INVENTION

One object of the present invention is to provide an electrical connector which can ensure a secure electrical connection between two mating electronic components.

To achieve the aforementioned object, the electrical connector according to the present invention comprises an insulating body provided with a plurality of accommodating passages; and an electrical terminal received in the accommodating passage and having a fastening portion on one side to fasten with the insulating body and a contact portion on the other side to be swingingly connected with.

Compared with the conventional art, the electrical connector according to the present invention can maintain better resilience without loosening and thus ensure secure electrical connection with mating electronic.

### BRIEF DESCRIPTION OF THE DRAWINGS

The present invention can be more fully understood by reference to the following description and accompanying drawings, in which:

FIG. 1 schematically illustrates a perspective assembly view of a preferred embodiment of the electrical connector according to the present invention;

FIG. 2 schematically illustrates a local perspective view of the electrical connector in FIG. 1 from another view angle;

FIG. 3 schematically illustrates a local perspective view of the electrical connector in FIG. 1 from yet another view angle.

FIG. 4 schematically illustrates an exploded perspective view of the electrical connector in FIG. 1.

### DETAILED DESCRIPTION OF THE INVENTION

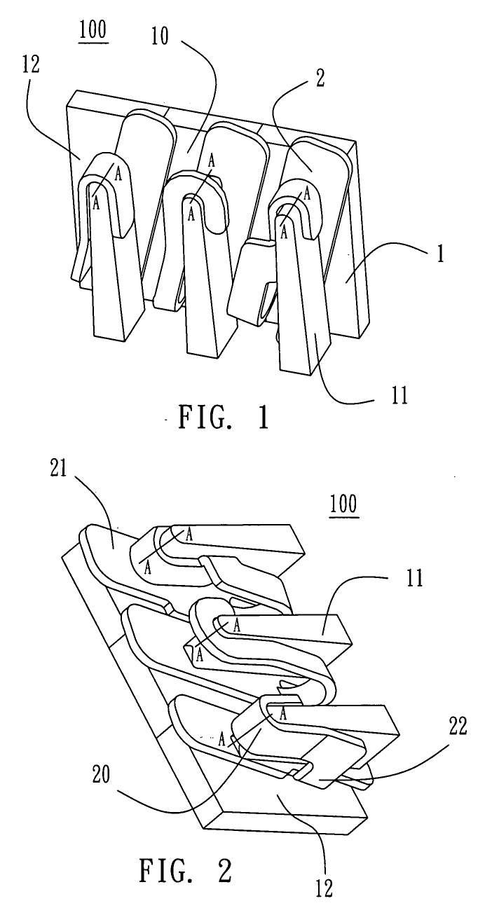

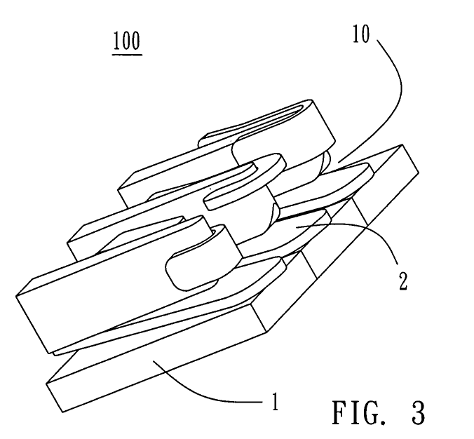

With reference to FIGS. 1 to 4, the electrical connector according to the present invention is to establish electrical connection between two mating electronic components, for example but not limited to, connecting the Land Grid Array (LGA) chip module to a circuit board (both not shown). Of course, the electrical connector can also establish electrical connection for other electronic components, for example but not limited to, two circuit boards and so on. The electrical connector according to the present invention comprises an insulating body 1; an electrical terminal 2 whose one side is provided with a fastening portion 20 to fasten with the insulating body 1 and other side is provided with a contact portion 21 to be swingingly connected with, wherein the insulating body 1 is provided with a plurality of accommodating passages 10 and the electrical terminal 2 is received in the accommodating passage 10 of the insulating body 1. The insulating body 1 is further provided with a locating portion 11 to operate with the fastening portion 20 so as to render the electrical terminal 2 securingly fastened onto the insulating body 1 (of course, holes (not shown) may be provided on the locating portion 11 and the fastening portion 20 of the electrical terminal 2 may be inserted therein for fastening).

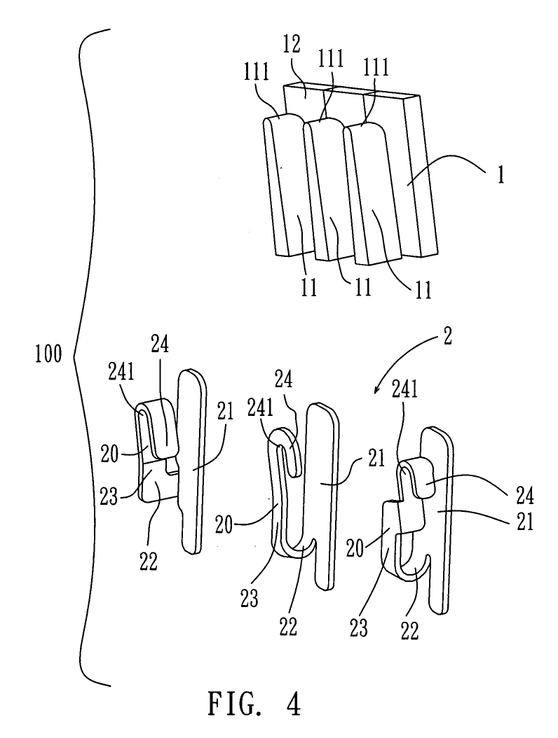

The electrical terminal 2 having a strip shape which is, for example but not limited to, formed by stamping may be inserted into the accommodating passage 10. The electrical terminal 2 further comprises a connecting portion 22, a contact portion 21 extending from both ends of the connecting portion 22, and a fastening portion 20 extending upwards and then extending downward from the middle of the connecting portion 22 (the first electrical terminal from the left in FIG. 4). Of course, the electrical terminal 2 may also comprise a connecting portion 22, a contact portion 21 extending from both ends of the connecting portion 22, and a fastening portion 20 bending upwards, extending, and then bending downward from one end of the connecting portion 22 (the second electrical terminal from the left in FIG. 4). Alternatively, the electrical terminal 2 may also comprise a connecting portion 22, a contact portion 21 extending from both ends of the connecting portion 22, and a fastening portion 20 bending upwards, extending, bending upwards, and then bending downward from one end of the connecting portion 22 (the third electrical terminal from the left in FIG. 4). The two contact portions 21 may be disposed on the same vertical line or may be alternatively disposed vertically.

The fastening portion 20 and the contact portion 21 are disposed face to face in parallel. Of course, the fastening portion 20 and the contact portion 21 may also be perpendicularly disposed. The connecting portion 22 is to connect the fastening portion 20 with the contact portion 21 and to provide the resilience of the contact portion 21.

Upon assembling, when the mating electronic component is connected with the electrical terminal 2, the connecting portion 22 can provide sufficient resilience to render a better electrical connection between the contact portion 21 of the electrical terminal 2 and the mating electronic component when the contact portion 21 is to be swingingly connected with. When the mating electronic component is disengaged, the contact portion 21 of the electrical terminal 2 may return to original shape due to the resilience of the connecting portion 22.

Consequently, the electrical connector according to the present invention can maintain better resilience without loosening and thus ensure secure electrical connection with mating electronic components, which can overcome the drawbacks of the conventional art.

While the invention has been described with reference to the a preferred embodiment thereof, it is to be understood that modifications or variations may be easily made without departing from the spirit of this invention, which is defined by the appended claims.

1-9. (canceled)

10. An electrical connector comprising:
a) an insulating body having a plurality of accommodating passages, each accommodating passage of the plurality of accommodating passages has a locating portion having a first contact surface located on an end of the locating portion, the first contact surface having an arch shape; and
b) a plurality of electrical terminals located in the plurality of accommodating passages, each of the plurality of electrical terminals has:
i) a fastening portion located on a first side thereof and having a second contact surface selectively connected to the first contact surface of the locating portion of a corresponding one of the plurality of electrical terminals, a junction line is formed between the first contact surface and the second contact surface; and
ii) a contact portion located on a second side thereof and pivoting about the junction line.

11. The electrical connector according to claim 10, wherein the fastening portion and the contact portion are disposed face to face.

12. The electrical connector according to claim 10, wherein the fastening portion and the contact portion are disposed in parallel.

13. The electrical connector according to claim 10, wherein the electrical connector further comprises a connecting portion to connect the fastening portion with the contact portion.

14. The electrical connector according to claim 10, wherein the electrical terminal further comprises a connecting portion, a contact portion extending from both ends of the connecting portion, and a fastening portion formed by extending sideward, upward, and then bending downward from the middle of the connecting portion.

15. The electrical connector according to claim 10, wherein the electrical terminal further comprises a connecting portion, a contact portion extending from both ends of the connecting portion, and a fastening portion formed by bending upward, extending, and then bending downward from one end of the connecting portion.

16. The electrical connector according to claim 10, wherein the electrical terminal further comprises a connecting portion, a contact portion extending from both ends of the connecting portion, and a fastening portion formed by bending upward, extending, and then bending upward and downward from one end of the connecting portion.

17. The electrical connector according to claim 10, wherein the electrical connector further comprises two contact portions being alternatively disposed vertically.
